(19) United States
(12) Patent Application Publication
(10) Pub. No.: US 2025/0272811 A1
(43) Pub. Date: Aug. 28, 2025

(54) CORRECTED QUADTREE BACK-PROJECTION FOR LARGE TARGET NEAR-FIELD IMAGING

(71) Applicant: Kabushiki Kaisha Toshiba, Tokyo (JP)

(72) Inventors: Mustafa Tarik AL-ANI, Bristol (GB); Seifallah JARDAK, Bristol (GB)

(73) Assignee: Kabushiki Kaisha Toshiba, Tokyo (JP)

(21) Appl. No.: 18/586,231

(22) Filed: Feb. 23, 2024

(51) Int. Cl. G06T 5/80; G01S 13/90; G06T 3/40; G06T 7/11; G06T 15/00

(52) U.S. Cl. CPC G06T 5/80; G01S 13/9021; G06T 3/40; G06T 7/11; G06T 15/00; G06T 2207/10028

(57) ABSTRACT

Provided is a method of near-field radar image reconstruction from radar data, the method comprising receiving radar data corresponding to an image, segmenting the image into multiple sub-images, wherein each sub-image comprises a section of the image, and for each sub-image, generating shifted data, by multiplying the radar data by a shifting term, wherein the shifting term accounts for a distance between the centre of the image and a centre of the sub-image, wherein the centre of the sub-image is corrected for a curvature of a wavefront of a radar pulse, generating reduced data by filtering and downsampling the shifted data, such that the total amount of the shifted data is reduced and reconstructing the sub-image, by back-projecting the reduced data, wherein performing the shifting by using the shifting term reduces distortion in the reconstructed sub-image.

### FIELD

Embodiments described herein relate to systems and methods for image reconstruction using hierarchical decomposition.

### BACKGROUND

Radar imaging is widely used for military and civil applications such as mapping and surveying an area of interest from the sky and controlling sea borders. Radar imaging technologies can be grouped into two main categories: (i) real-aperture radar imaging typically realised using an array of antennas with Multi-Input Multi-Output (MIMO), and (ii) synthetic-aperture radar imaging based on the knowledge of the relative motion between the object which is typically realised using a single antenna. The latter can be divided in two techniques. If the radar and the object are moving in a controlled manner, Synthetic Aperture Radar (SAR) algorithms can extract cross-range information and create a range-cross-range 2D image from multiple 1D range profiles. When imaging moving objects, Inverse SAR (ISAR) methods are applied to first estimate and then compensate their motion. Later, an image formation algorithm coherently processes the scans to obtain a radar image.

Doppler-Beam Sharpening (DBS) is one of the most commonly used image formation algorithms for SAR/ISAR. Its merit lies in its full use of the Fast Fourier Transform (FFT) in both dimensions, which can significantly minimise processing load. However, the DBS algorithm relies on geometric approximations that break down in various limits. First, large coherence time and large integration angles, which are necessary for high resolution imaging, lead to range and Doppler migrations and hence an unfocused image. Second, large targets with respect to their distance to the radar can lead to images with distorted dimensions. Third, the wave front curvature that is evident in near-field imaging, is not accounted for in DBS, and negatively affects the quality of the image. Various algorithms to tackle each of these issues have been proposed in the literature. However, the resulting computation required for each of these corrections is so costly that the initial DBS approximations are no longer practical.

Back-Projection (BP) is a more exact image formation algorithm which uses fewer approximations at the expense of substantially greater processing time. Given the history of the relative motion between the target and the radar, the value of an image pixel according to the BP algorithm is the contribution (i.e., summation) from all the radar range profiles. Thus, to reconstruct an image of size N×N using P=O(N) radar range profiles, using BP, the total number of back-projections required is equal to PN² and computations are in the order of O(N³). To reconstruct a 3D volume image of size N×N×N using P=O(N²) radar range profiles, using BP, the total number of back-projections required is equal to PN³ and computations are in the order of O(N⁵).

Quadtree Back-Projection is an accelerated version of the standard BP reconstruction using hierarchical decomposition. Under the same circumstances, the Quadtree BP algorithm can reduce the computational cost to O(N² log N) and O(N³ log N) in 2D and in 3D imaging, respectively.

The central idea of this fast algorithm is rooted in the angular bandlimited property, or the so-called bow-tie approximation, of the Radon transform of an image—images that are half the size of the original image can be reconstructed from half the number of projections. This theorem can be extended to the 3D Radon transform in azimuth and elevation angles. By dividing the original image into four (or eight for 3D) sub-images, we reduce the computation by a factor of two (or four in 3D imaging). If this decomposition algorithm is then applied recursively to each of the sub-images, followed by back-projecting using half (or quarter for 3D) the number of projections for the smaller sub-images, the O(N² log N) (or O(N³ log N) for 3D imaging) computational cost can be achieved.

However, Quadtree BP suffers from significant distortion when imaging a large target at near-field, specifically when rₛ>ε\sqrt{r₀Δᵣ}, where rₛ is the radius of the target, r₀ is the distance from the centre of the target to the radar transceiver, Δᵣ is the radar range resolution, and ε controls the amount of tolerated error. In typical mmWave security scanners settings, significant distortion is observed when rₛ>0.2 m. The distortion occurs because Quadtree BP does not account for the curvature of the wave front, which compromises the data shifting and the back-projection to form the sub-images.

### BRIEF DESCRIPTION OF THE DRAWINGS

Embodiments will now be described by way of example with reference to the accompanying drawings in which:

FIG. 1 shows a flowchart describing the classical method for performing Quadtree BP.

FIG. 2 shows a flowchart describing a method for performing corrected Quadtree BP according to an embodiment.

FIG. 3 shows the locations of the centres of 7.5×7.5 cm² sub-images, at the third depth of Quadtree decomposition, for an image of size 60×60 cm².

FIG. 4A shows the locations of the centres of 7.5×7.5 cm² sub-images at the third depth of Quadtree decomposition for an image of size 60×60 cm² at far-field, at tₘ=0, in the Range-Doppler domain.

FIG. 4B shows the locations of the sub-images centres from 4A as the target rotates 360° around the centre.

FIG. 5A shows the locations of the centres of 7.5×7.5 cm² sub-images at the third depth of Quadtree decomposition for an image of size 60×60 cm² at a distance of one metre to the radar, at tₘ=0, in the Range-Doppler domain.

FIG. 5B shows the locations of the image centres from 5A as the target rotates 360° around the centre.

FIG. 6 shows an image of a mesh target of size 60×60 cm², with 9×9 point-scatterers.

FIG. 7A shows the 2D Fast Fourier Transform magnitude, in dB, of the radar data of the Mesh target at a distance of 18 metres from the radar.

FIG. 7B shows the 2D Fast Fourier Transform magnitude, in dB, of the radar data of the Mesh target at a distance of 1 metre from the radar.

FIG. 8A shows the reconstruction of the radar image of the mesh target from a distance of 1 metre from the radar, according to the classical method of Quadtree BP.

FIG. 8B shows the reconstruction of the radar image of the mesh target from a distance of 1 metre from the radar, according to a method for performing corrected Quadtree BP, according to an embodiment.

FIG. 9 shows a flowchart describing the classical method for performing decimation-in-image BP.

FIG. 10 shows a flowchart describing a method for performing corrected decimation-in-image BP according to an embodiment.

### DETAILED DESCRIPTION

According to a first embodiment, there is provided a method of near-field radar image reconstruction from radar data, the method comprising:
receiving radar data corresponding to an image;
segmenting the image into multiple sub-images, wherein each sub-image comprises a section of the image, and for each sub-image:
   generating shifted data, by multiplying the radar data by a shifting term, wherein the shifting term accounts for a distance between the centre of the image and a centre of the sub-image, wherein the centre of the sub-image is corrected for a curvature of a wavefront of a radar pulse;
   generating reduced data by filtering and downsampling the shifted data, such that the total amount of the shifted data is reduced; and
   reconstructing the sub-image, by back-projecting the reduced data;
wherein performing the shifting by using the shifting term reduces distortion in the reconstructed sub-image.

The method may further comprise shifting the reduced data, by multiplying the reduced data by an inverse shifting term before reconstructing, wherein the inverse shifting term shifts the reduced data to its original location.

The steps consisting of segmenting the image, generating shifted data, generating reduced data and shifting the reduced data may be performed iteratively, wherein at least one of the sub-images at the end of one iteration becomes the image to be segmented in the next iteration.

The method may be performed iteratively until a maximum level of decomposition for all sub-images is reached. The maximum level of decomposition for a sub-image may be determined to have been reached when the sub-image comprises a single pixel or a single voxel of the image.

The method may be performed iteratively until a maximum level of decomposition for all sub-images is reached, wherein the maximum level of decomposition for a sub-image is determined to have been reached when the sub-image contains no data representative of a target object.

The shifting of the reduced data at the end of one iteration and the segmentation of the image and generation of shifted data of a subsequent iteration may be performed as one multiplication.

The centre of the sub-image may be corrected for the curvature of the wavefront using the following approximation:

$$i . {\hat{y}}_{s} = {y}_{s} + \frac{{x}_{s}^{2}}{2 {r}_{0}} - \frac{{y}_{s} {x}_{s}^{2}}{2 {r}_{0}^{2}}$$

$$ii . {\hat{x}}_{s} = {x}_{s} - \frac{{x}_{s} {y}_{s}}{{r}_{0}} - \frac{{x}_{s} ( {x}_{s}^{2} - 2 {y}_{s}^{2} )}{2 {r}_{0}^{2}}$$

wherein (\hat{x}ₛ,ŷₛ) is the corrected centre of the sub-image, (xₛ,yₛ) is the original centre of the sub-image, and r₀ is the distance of a centre of the image to the radar.

The image may be a two-dimensional image, and segmenting the image into multiple sub-images may consist of segmenting the image into four sub-images, wherein each sub-image is a quarter of the image.

The image may be a three-dimensional image, and segmenting the image into multiple sub-images may consist of segmenting the image into eight sub-images, wherein each sub-image is an eighth of the image.

The data may be received by a mmWave radar system.

The target object may be of a size approximately comparable with its distance from the radar system.

According to another embodiment, there is provided a computer system configured to perform any of the methods described above.

According to a further embodiment, there is provided a non-transitory computer-readable storage medium comprising computer executable instructions that when executed by a computer will cause the computer to perform any of the methods described above.

According to another embodiment, there is provided a method of near-field radar image reconstruction from radar data, the method comprising:
receiving radar data corresponding to an image;
segmenting the radar data into multiple data sections, and for each data section:
   back-projecting the data section to form an intermediate image;
   shifting the intermediate image by multiplying each pixel of the intermediate image by a shifting term, wherein the shifting term accounts for a distance between a centre of the data segment and a corrected image grid, wherein the corrected image grid accounts for a curvature of a wavefront of a radar pulse;
   upsampling the intermediate image;
   aggregating the intermediate image with intermediate images formed from other data sections of the multiple data sections.

The intermediate image may be aggregated with intermediate images formed from adjacent data sections.

The method may further comprise shifting the intermediate image after upsampling, by multiplying each pixel of the intermediate image by an inverse shifting term before aggregating, wherein the inverse shifting term shifts the intermediate image to its original location.

The radar data may be segmented iteratively, generating progressively smaller data sections.

The radar data segmentation may iterate until a maximum level of decomposition for each data section is reached.

The maximum level of decomposition may be determined to have been reached when the data section comprises a single element of data.

The intermediate images may be aggregated iteratively until a single image is formed.

The corrected image grid may account for the curvature of the wavefront using the following approximation:

$$\hat{y} = y + \frac{{x}^{2}}{2 {r}_{0}} - \frac{{yx}^{2}}{2 {r}_{0}^{2}} . \qquad i$$

$$\hat{x} = x - \frac{xy}{{r}_{0}} - \frac{x ( {x}^{2} - 2 {y}^{2} )}{2 {r}_{0}^{2}} . \qquad ii$$

wherein (\hat{x},ŷ) is a corrected pixel location in the image, (x, y) is an original pixel location in the image, and r₀ is a distance between a full image centre and a radar sensor.

The data may be received by a mmWave radar system.

The target objection may be of a size approximately comparable with its distance from the radar system.

According to another embodiment, there is provided a computer system configured to perform any of the methods described above.

According to a further embodiment, there is provided a non-transitory computer-readable storage medium comprising computer executable instructions that when executed by a computer will cause the computer to perform any of the methods described above.

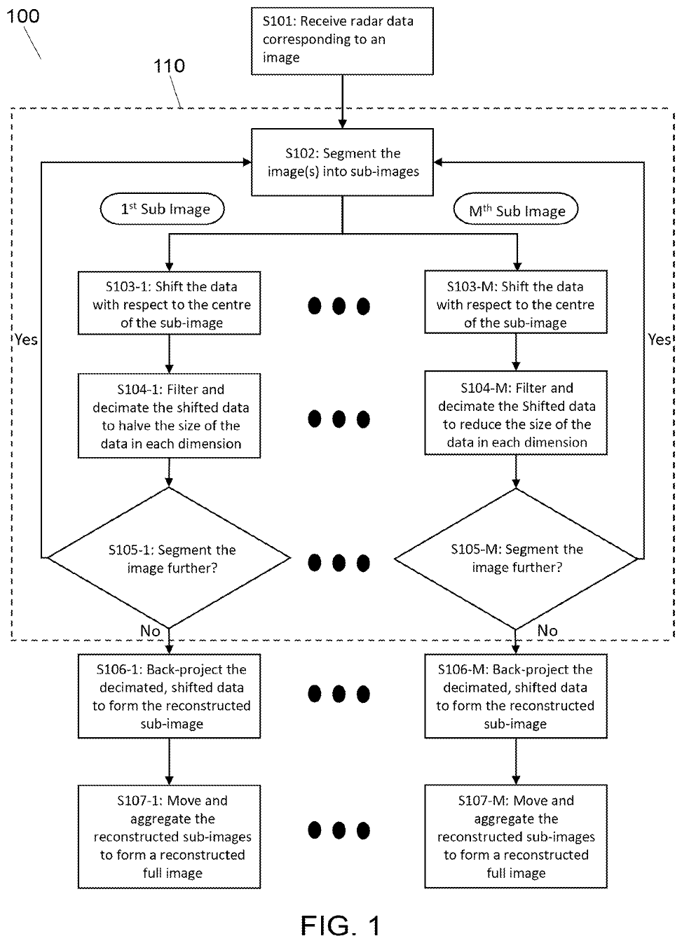

FIG. 1 shows a flowchart depicting a method 100 for performing Quadtree Back-Projection (BP), according to the conventional approach. Quadtree BP is a method of image reconstruction, which can be used to reconstruct an image based on data received at a radar system. Radar systems often alternate between emitting regular pulses of electromagnetic waves, and listening for reflected signals incident at the radar system from target objects.

The conventional Quadtree BP process 100 commences with step S101, at which radar data corresponding to an image is received from a radar system. The image may contain one or more target objects. In some embodiments, the radar data comprises signals received and demodulated at the radar system from a set of P emitted pulses. The radar data may be stored two-dimensionally, along fast and slow time axes. In some embodiments, the full image may be a two-dimensional image, of size N×N, and the data may comprise data received from P=O(N) pulses. In alternative embodiments, the full image may be a three-dimensional image, of size N×N×N, and the data may comprise data received from P=O(N²) pulses.

The hierarchical decomposition process 110 begins with step S102, at which the image is segmented into multiple sub-images. The segmentation may be carried out such that the image is segmented into multiple sub-images, wherein each sub-image comprises of a section of the image, and wherein combination of all sub-images would result in the image. In some embodiments, the image may be segmented into multiple equally-sized sub-images.

In embodiments where the image is a two-dimensional image, segmenting the image may consist of segmenting into four sub-images, wherein each sub-image comprises a quarter of the image. The segmentation of the image into four may be performed by dividing the image at the halfway point of the axis corresponding to each dimension.

In embodiments where the image is a three-dimensional image, segmenting the image may consist of segmenting into eight sub-images, wherein each sub-image comprises an eighth of the image. The segmentation of the image into eight may be performed by dividing the image at the halfway point of the axis corresponding to each dimension.

Upon a first iteration of the hierarchical decomposition process, the full image may be taken as the image for hierarchical decomposition. If the decomposition is performed multiple times, in further iterations of the decomposition process there may be multiple parent images for hierarchical decomposition, formed from previous segmentation processes, and each of which may be segmented into further sub-images.

Steps S103 to S107 may be carried out independently and in parallel for each sub-image. In FIG. 1, S103-1 refers to step S103 as carried out on the 1^{st} sub-image, while S103-M refers to step S103 as carried out on the M^{th} sub-image. While not explicitly shown in FIG. 1, steps S103 to S107 may be carried out for all of the sub-images. The number of sub-images present will necessarily increase with each iteration of hierarchical decomposition.

At step S103 of the conventional method, the data may be shifted so that the centre of the relevant sub-image coincides with the centre of its parent image after the shift. This operation may be carried out separately for each sub-image. Typically, to shift the data with respect to the centre of the sub-image (xₛ, yₛ), it can be multiplied by

$$exp ( \frac{\text{?}}{c} ) ,$$

$$\text{?} \text{indicates text missing or illegible when filed}$$

where f_{c} is the chirp carrier frequency of the emitted pulse signal, μ is the chirp rate, \hat{t} is the fast time value, tₘ is the pulse time, c is the speed of light, and S(xₛ, yₛ, tₘ) is the difference between the range of the centre of the sub-image (xₛ, yₛ) and the range of the centre of its parent image relative to the radar at tₘ.

In the conventional approach to Quadtree BP, this range difference can be obtained through:

$$S ( {x}_{s} , {y}_{s} , {t}_{m} ) = {x}_{s} cos ( Ω {t}_{m} ) - {y}_{s} sin ( Ω {t}_{m} ) \qquad ( 1 )$$

where Ω is the rotational rate of the radar in SAR imaging, or the rotational rate of the target in ISAR imaging. This expression allows quick calculation of the range difference by only two multiplications and a summation per pulse, as the sinusoidal components need only be calculated once per target imaging.

At step S104 of the method, the shifted data can be filtered and decimated to form reduced data. As discussed above, the bandlimited properties of the Radon transform of an image result in the ability to reconstruct an image from a number of projections which is half of that required for an image which is twice as large in each dimension. Therefore, for example, the P projections required to reconstruct an N×N object can be reduced to P/2 projections of four N/2×N/2 objects. This may take place by applying an angular decimation operator to the data, by angularly convolving the data with a low-pass filter, before downsampling it. In some embodiments, the shifted data may be downsampled by a factor of two, halving the amount of data present, such that the reduced data is data obtained from half of the original number of projections.

At step S105, it can be determined as to whether the sub-image is to be segmented further. The decomposition may be performed any number of times. In some embodiments, the decomposition is performed iteratively until a maximum depth of hierarchical decomposition has been reached for each sub-image. In some embodiments, the maximum depth of hierarchical decomposition may be determined to have been reached when the size of the sub-image is equal to one pixel (for two-dimensional sub-images), or one voxel (for three-dimensional sub-images). If the method determines that the maximum depth of hierarchical decomposition has not been reached, it may designate the current set of sub-images as a new set of parent images, and begin another iteration of hierarchical decomposition on each of these parent images.

In some embodiments, the maximum depth of hierarchical decomposition for a sub-image may be determined to have been reached when the data corresponding to that sub-image contains no data representative of one or more target objects. In these embodiments, the sub-image may be designated as an empty image, and may not be decomposed any further, while further iterations of the hierarchical decomposition process may continue to be performed on the other sub-images. In this way, computational expense can avoid being wasted on decomposing sub-images which contain no data relevant for the reconstruction of the image. These computational savings are valuable when implementing security scanners that output 3D real-time video streams. This also proves useful in automatic target recognition applications, for example to allow a pre-screening detector to be applied at an intermediate (or lower resolution) stage, and have the image formation proceed to high resolution only in areas likely to contain targets.

At step S106, once it has been determined that no further segmentation is to be performed, the reduced data can be back-projected, to form a reconstructed sub-image. In some embodiments, the hierarchical decomposition may have decomposed a two-dimensional N×N image into N² single pixel images. In these embodiments, the back-projection operation may consist of performing N² back-projections, wherein each back-projection consists of the back-projection of P/N projections onto a single pixel. N² back-projections of single pixels will result in N² reconstructed sub-images. Alternatively, in some embodiments, the hierarchical decomposition may have decomposed a three-dimensional N×N×N image into N³ single voxel images. In these embodiments, the back-projection operation may consist of performing N³ back-projections, of P/N projections onto a single voxel.

Finally, at step S106, the set of reconstructed sub-images can be aggregated, to form a reconstructed full image. In some embodiments, each individual reconstructed sub-image may consist of a single pixel or voxel of the reconstructed full image. In some embodiments, the maximum depth is set such that each reconstructed sub-image may consist of a region of the reconstructed full image larger than a single pixel or voxel. In some embodiments, where a sub-image was designated as empty and was not decomposed further, the corresponding region of the full image may consist of more than a single pixel or voxel and may be set to zero without back-projection.

The conventional method of Quadtree BP provides an improvement in the processing time of image reconstruction over BP. However, the high resolution and the high integration level of mmWave radars have allowed them to become small, cheap, and increasingly attractive to use in security scanners to image a person. Typically, in mmWave scanner imaging, where the distance from the centre of the target to the radar transceiver r₀≈1 m and the radius of the target rₛ>0.2 m, the standard far-field approximation of the planar wave front begins to fail. The curvature of the wavefront is not taken into account in conventional Quadtree BP, leading to a sub-optimal image quality in the reconstructed image.

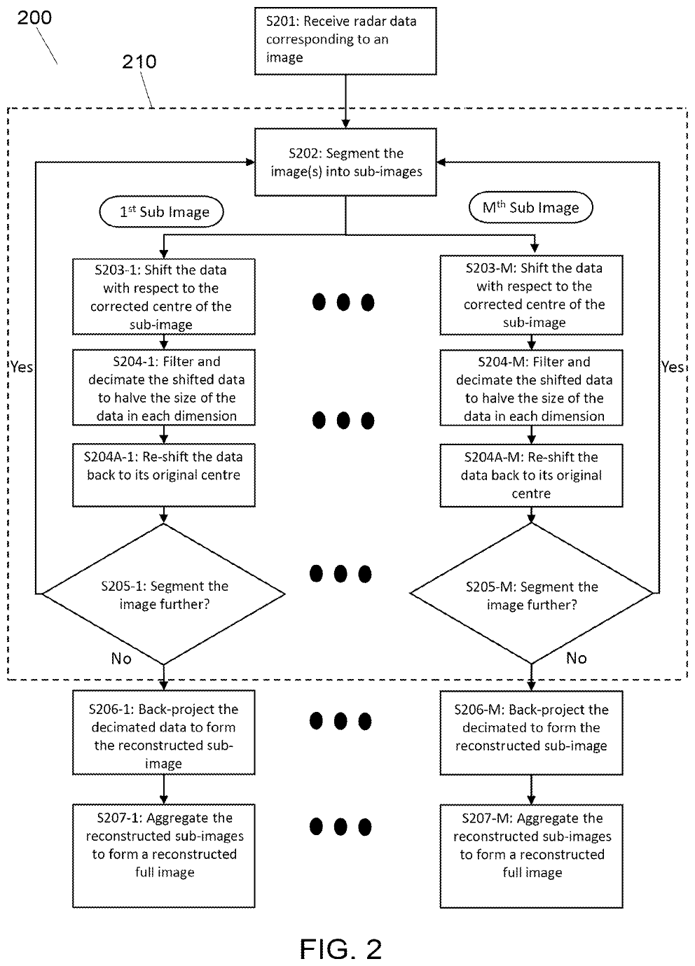

FIG. 2 depicts a method 200 of performing Quadtree BP in which the curvature of the wavefront is taken into account, according to an embodiment. The corrected Quadtree BP process 200 commences with step S201, at which radar data corresponding to an image is received. The image may contain one or more target objects. In some embodiments, the data comprises the signals received and demodulated at the radar system from a set of P emitted pulses. In some embodiments, the image may be a two-dimensional image, of size N×N, and the data may comprise data received from P=O(N) pulses. In alternative embodiments, the image may be a three-dimensional image, of size N×N×N, and the data may comprise data received from P=O(N²) pulses.

The hierarchical decomposition process 210 begins with step S202, at which the image is segmented into multiple sub-images. The segmentation may be carried out such that the image is segmented into multiple sub-images, wherein each sub-image comprises of a section of the image, and wherein combination of all sub-images would result in the image. In some embodiments, the image may be segmented into multiple equally-sized sub-images.

In embodiments where the image is a two-dimensional image, segmenting the image may consist of segmenting into four sub-images, wherein each sub-image comprises a quarter of the image. The segmentation of the image into four may be performed by dividing the image at the halfway point of the axis corresponding to each dimension.

In embodiments where the image is a three-dimensional image, segmenting the image may consist of segmenting into eight sub-images, wherein each sub-image comprises an eighth of the image. The segmentation of the image into eight may be performed by dividing the image at the halfway point of the axis corresponding to each dimension.

Upon a first iteration of the hierarchical decomposition process, the full image may be taken as the image for hierarchical decomposition. If the decomposition is performed multiple times, in further iterations of the decomposition process there may be multiple parent images for hierarchical decomposition, formed from previous segmentation processes, and each of which may be segmented into further sub-images.

Steps S203 to S207 may be carried out independently and in parallel for each sub-image. In FIG. 2, S203-1 refers to step S203 as carried out on the 1^{st} sub-image, while S203-M refers to step S203 as carried out on the M^{th} sub-image. While not explicitly shown in FIG. 2, steps S203 to S207 may be carried out for all of the sub-images. The number of sub-images present will necessarily increase with each iteration of hierarchical decomposition.

At step S203, the corrected Quadtree BP method implements a correction to the shifting step, to account for the wave curvature when calculating the range difference between the centre of the sub-image (xₛ,yₛ) and the centre of the full image (r₀,0) relative to the radar. The data is shifted using the same expression as before, but this time the range difference is modified to account for the curvature of the wavefront. Equation (2) below represents an exact expression for this range difference:

$$S ( {x}_{s} , {y}_{s} , {t}_{m} ) = \sqrt{{( {x}_{s} cos ( Ω {t}_{m} ) - {y}_{s} sin ( Ω {t}_{m} ) + {r}_{0} )}^{2} + {( {x}_{s} sin ( Ω {t}_{m} ) + {y}_{s} cos ( Ω {t}_{m} ) )}^{2}} - {r}_{0} \qquad ( 2 )$$

where r₀ is the distance of the full image centre to the radar. Using equation (2) to calculate the range difference would account for the curvature of the wavefront. However, as discussed above, one of the benefits of equation (1) is the relative computational simplicity, allowing for faster calculation. Equation (2) adds significant computational expense to the process, and thus results in a less computationally efficient method of image reconstruction.

To facilitate the use of equation (1) while still accounting for the wave curvature, a correction can instead be introduced to the centre of each sub-images, (xₛ, yₛ). If the ratio

$$γ = \frac{{r}_{s}}{{r}_{0}} < 0.4 ,$$

the sub-image centre location can be approximated with

$${\hat{y}}_{s} = {y}_{s} + \frac{{x}_{s}^{2}}{2 {r}_{0}} - \frac{{y}_{s} {x}_{x}^{2}}{2 {r}_{0}^{2}} \qquad ( 3 )$$

$${\hat{x}}_{s} = {x}_{s} - \frac{{x}_{s} {y}_{s}}{{r}_{0}} - \frac{{x}_{s} ( {x}_{s}^{2} - 2 {y}_{s}^{2} )}{2 {r}_{0}^{2}} \qquad ( 4 )$$

where (\hat{x}ₛ,ŷₛ) represents the corrected sub-image centre. By using the corrected sub-image centres, the image reconstruction method can take into account the curvature of the wavefront, hence reducing distortion of images of large targets at near-field, while maintaining a low computational cost. This operation assumes that the integration angle is smaller than 30°. Further, the approximations in equations (3) and (4) depend only on the size and location of the full image, which means they can be pre-calculated prior to imaging.

At step S204 of the method, the shifted data can be filtered and decimated to form reduced data. As discussed above, the bandlimited properties of the Radon transform of an image results in the ability to reconstruct an image from a number of projections which is half of that required for an image which is twice as large in each dimension. Therefore, the P projections required to reconstruct an N×N object can be reduced to P/2 projections of four N/2×N/2 objects. This may take place by applying an angular decimation operator to the data, by angularly convolving the data with a low-pass filter, before downsampling it. In some embodiments, the shifted data may be downsampled by a factor of two, halving the amount of data present, such that the reduced data is data obtained from half of the original number of projections.

At step S204A-1, the reduced data may be shifted back to its original location. This may be done by multiplying the data, after decimation, by

$$exp ( \frac{\text{?}}{c} ) ,$$

$$\text{?} \text{indicates text missing or illegible when filed}$$

where Ŝ(\hat{x}ₛ, ŷₛ, tₘ) is the range difference calculated using the corrected centres of the sub-images.

If this step is performed, when the back-projection operation is performed, it is performed on the sub-images at their original locations, rather than shifted to the centre of the full image. This ensures that the effect of the approximation in equations (3) and (4) does not negatively affect the reconstruction of the full image. At near range, shifting the data results in the image pixels becoming out of focus with unique projection paths. Shifting the data back to its original location prevents this problem.

The data shifting of steps S203 and S204A can be combined into one multiplication instead of two multiplications when the chart flows through S204A->S205->S202->S203 as hierarchical depth increments, to save on computational cost. By virtue of these amendments to the Quadtree BP method, the curvature of the wavefront can be accounted for and hence the quality of the reconstructed image of a large target object at near-field can be improved.

At step S205, it can be determined as to whether the sub-image is to be segmented further. The decomposition may be performed any number of times. In some embodiments, the decomposition is performed iteratively until a maximum depth of hierarchical decomposition has been reached for each sub-image. In some embodiments, the maximum depth of hierarchical decomposition may be determined to have been reached when the size of the sub-image is equal to one pixel (for two-dimensional sub-images), or one voxel (for three-dimensional sub-images). If the method determines that the maximum depth of hierarchical decomposition has not been reached, it may designate the current set of sub-images as the new set of parent images, and begin another iteration of hierarchical decomposition on these parent images.

In some embodiments, the maximum depth of hierarchical decomposition for a sub-image may be determined to have been reached when the data corresponding to that sub-image contains no data representative of a target object. In these embodiments, the sub-image may be designated as an empty image, and may not be decomposed any further, while further iterations of the hierarchical decomposition process may continue to be performed on the other sub-images. In this way, computational expense can be avoided on decomposing sub-images which contain no data relevant for the reconstruction of the image. These computational savings are valuable when implementing security scanners that output 3D real-time video streams. This also proves useful in automatic target recognition applications, for example to allow a pre-screening detector to be applied at an intermediate (or lower resolution) stage, and have the image formation proceed to high resolution only in areas likely to contain targets.

At step S206, once it has been determined that no further segmentation is to be performed, the reduced data can be back-projected, to form a reconstructed sub-image. In some embodiments, the hierarchical decomposition may have decomposed a two-dimensional N×N image into N² single pixel images. In these embodiments, the back-projection operation may consist of performing N² back-projections, wherein each back-projection consists of the back-projection of P/N projections onto a single pixel. N² back-projections of single pixels will result in N² reconstructed sub-images. Alternatively, in some embodiments, the hierarchical decomposition may have decomposed a three-dimensional N×N×N image into N³ single voxel images. In these embodiments, the back-projection operation may consist of performing N³ back-projects, of P/N projections onto a single voxel.

Finally, at step S207, the set of reconstructed sub-images can be aggregated, to form a reconstructed full image. In some embodiments, each individual reconstructed sub-image may consist of a single pixel or voxel of the reconstructed full image. In some embodiments, where a sub-image was designated as empty and was not decomposed further, the corresponding reconstructed sub-image may consist of a region of the reconstructed full image larger than a single pixel or voxel.

The important difference between the conventional method of Quadtree BP and the corrected method disclosed herein, is that the corrected method accounts for wave curvature throughout the algorithm. Importantly, the embodiments disclosed herein achieve this goal at no additional computational cost, due to the approximations introduced by equations (3) and (4). These factors help to facilitate the imaging of large targets at near-field, for instance in mmWave security scanners, as well as other projection imaging applications.

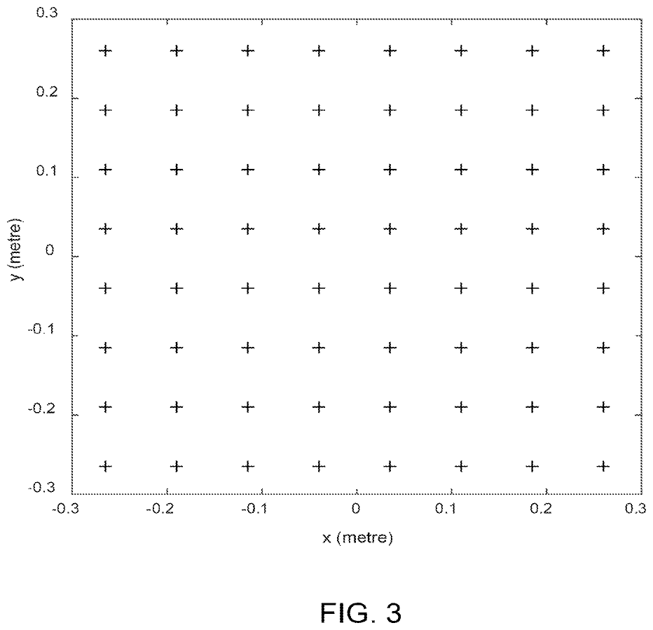

FIG. 3 shows the locations of the centres of 7.5×7.5 cm² sub-images, at the third depth of Quadtree decomposition, for an image of size 60×60 cm². It can be seen that at the third depth of Quadtree decomposition, a 60×60 cm² image may be decomposed into 64 sub-images. If it is determined that the sub-images can be decomposed further, due to not being at the maximum depth of decomposition, each of the sub-images present in FIG. 3 may be designated as parent images for the next iteration of decomposition. In some embodiments, therefore, the fourth depth of Quadtree decomposition may decompose a 60×60 cm² image into 256 sub-images. In some embodiments, not all sub-images may be designated as parent images, and thus may not be decomposed further in subsequent iterations of hierarchical decomposition. For instance, if it is determined that a sub-image contains no data representative of the target object, such as reflections of emitted pulses from a target object, the sub-image may be designated as empty, and not be decomposed any further. In this way, computational power can be focused more efficiently on decomposing sub-images containing relevant information for the reconstruction of the image, preventing wasted computational resources.

FIG. 3 depicts the third depth of Quadtree decomposition for a two-dimensional object. It will be appreciated that while FIG. 3, and the example described hereafter, are specifically two-dimensional, all of the embodiments practised within this disclosure are equally suitable for reconstruction of three-dimensional images.

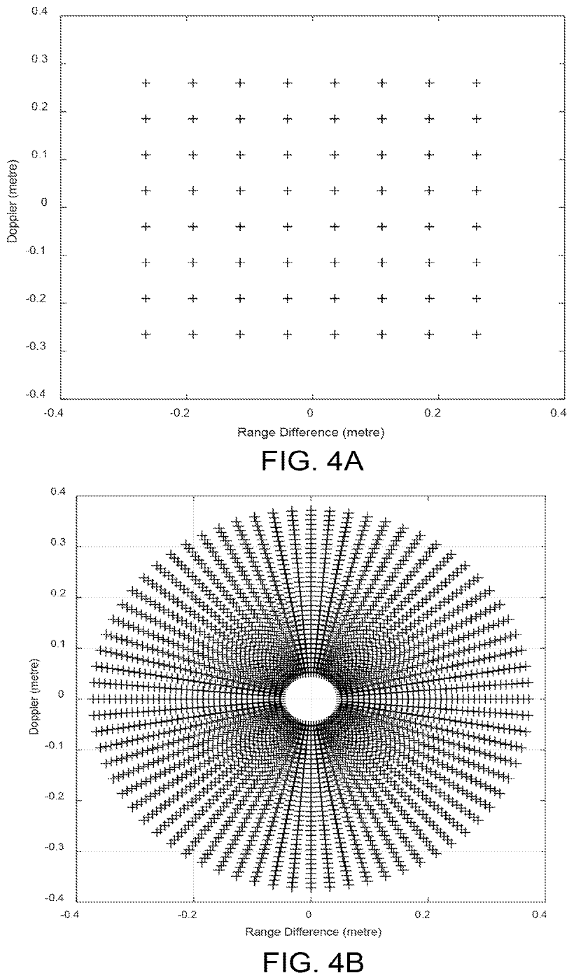

FIG. 4A shows the locations of the centres of 7.5×7.5 cm² sub-images at the third depth of Quadtree decomposition for an image of size 60×60 cm², from FIG. 3, at far-field at tₘ=0 in the Range-Doppler domain. It can be seen that, at far-field, the centres of these images are located in approximately the same locations in the Range-Doppler domain as they were in the Cartesian domain. This is due to the far-field approximation of the planar wavefront, as discussed above.

FIG. 4B shows the locations of the sub-image centres as the target rotates around its centre at (0,0). In SAR imaging, this rotation may be caused by the emitter rotating around the target object, whereas in ISAR imaging, this rotation may be rotation of the object. As the target rotates around its centre at (0,0), the sub-image centres can be seen to form perfect circles. Because of this, the range difference for a sub-image can be determined by equation (1) above.

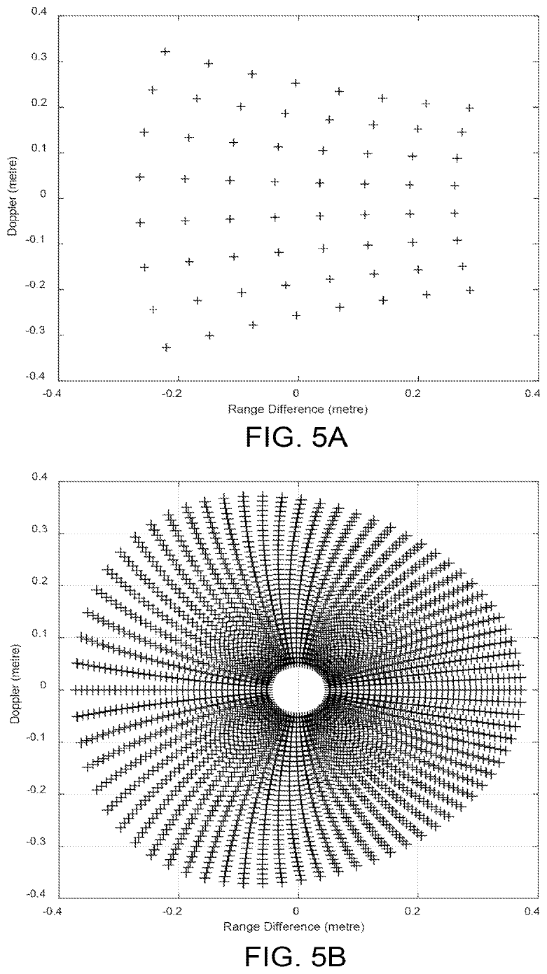

FIG. 5A shows the locations of the centres of 7.5×7.5 cm² sub-images at the third depth of Quadtree decomposition for an image of size 60×60 cm² from FIG. 3, at near-field at tₘ=0 in the Range-Doppler domain. When imaging an object with size comparable to its distance from the radar, it can be seen that the sub-image centres are not distributed the same in the Range-Doppler domain as they were in the Cartesian domain, and now are distributed within an annulus shape. This is due to the curvature of the wavefront, which is more prominent at near-field.

FIG. 5B shows the locations of the sub-image centres as the target rotates around its centre at (0,0). Due to the curvature of the wavefront, the sub-image centres can now be seen to follow an elliptical path around the centre. Due to this, equation (1) no longer provides acceptable results at near-field for the sub-image centres.

However, when the integration angle is less than 30°, the arcs followed by the sub-image centres around the ellipses can be approximated as arcs from circles. Due to this approximation, equation (1) can still be used with the corrected sub-image centres to determine the range difference, allowing for accommodation of the wavefront curvature without increased computational cost.

Further, because of the re-shifting step S204A, the effect of the approximation does not propagate through to the final image formation, as the data is shifted back to its original location by the same slightly approximated range differences.

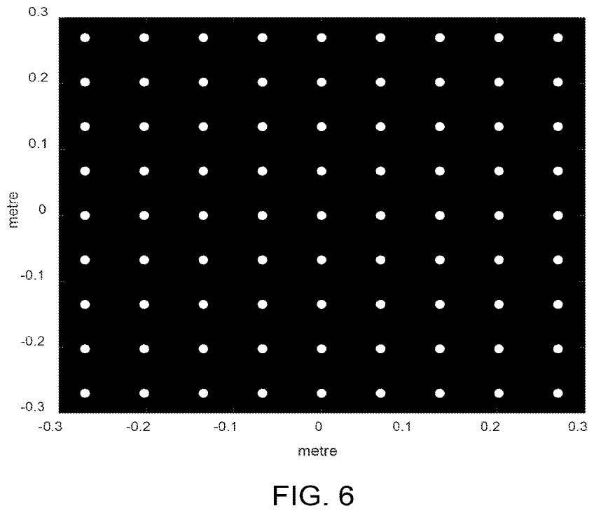

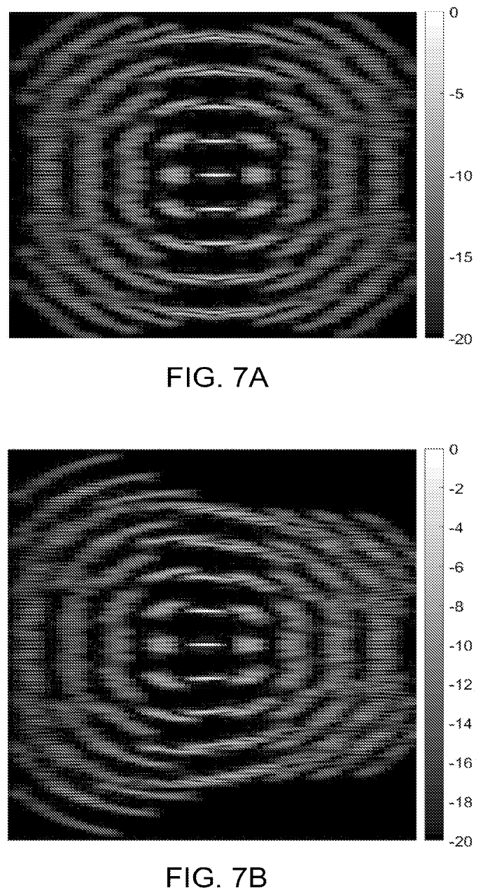

The necessity of the approximation for imaging of a near-field target can be seen from inspection of FIGS. 6 and 7. FIG. 6 depicts a mesh target in the Cartesian domain, with 9×9 point scatterers which can be depicted in a two-dimensional 60×60 cm² image.

FIGS. 7A and 7B depicts the two-dimensional FFT energy output of the received radar data from the mesh target of FIG. 6, for the far-field and near-field scenarios respectively. This is directly related to the filtering of the Quadtree BP, which is performed using FFT for computational efficiency. It can be seen how the energy in the near-field scenario in FIG. 7B is no longer squarely distributed, as it is in the far-field scenario. Instead, the energy is distributed throughout an annulus shape, highlighting the importance of the correction in step S203.

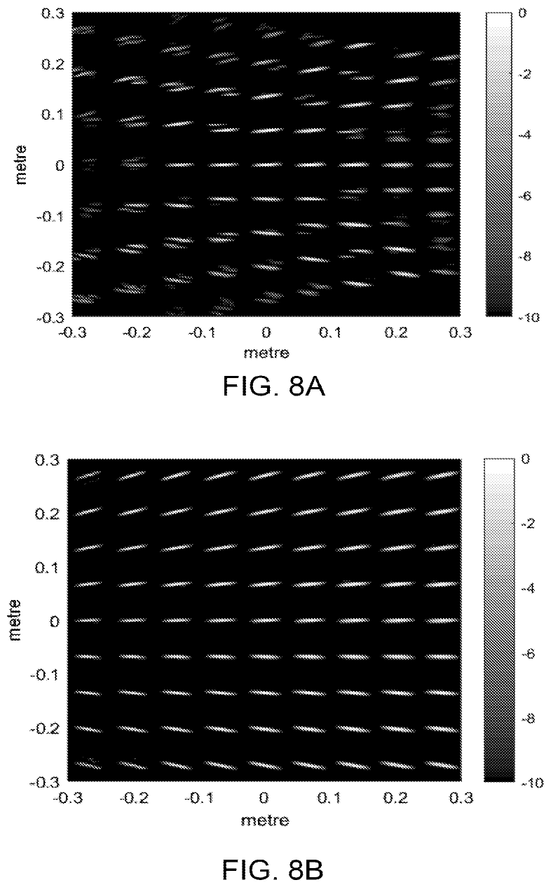

FIGS. 8A and 8B show the reconstructed images of the mesh target of size 60×60 cm² with 9×9 point scatterers centred at one metre from the radar, produced using the conventional method of Quadtree BP and the corrected method of Quadtree BP described herein, respectively. An image sharpness metric was calculated using the gradient magnitude of the image (i.e. the sum of all gradient norms/number of pixels), and comparison of FIGS. 8A and 8B showed an improvement in image sharpness by over 25% by the embodiment proposed herein.

In another embodiment, the introduced correction of (3) and (4) can also be applied to the dual of the Quadtree BP: a method known as decimation-in-image BP. According to this method, to reduce the computations required to reconstruct the image, the decimation is applied to the image rather than the radar data, and the Quadtree segmentation is applied to the radar data instead of the image, compared with the original method. Thus, decimation-in-image BP does not require the full radar data to subsample from to form the radar image, but instead can process segments of the radar data to produce low-resolution intermediate images that can be combined to produce the final image. This feature can offer additional advantages in real-time radar imaging.

However, the decimation-in-image BP may also introduce significant distortion when imaging a large target at near field. The introduced correction of (3) and (4) can be applied to the locations of the pixels of the original image to overcome this problem with negligible extra computations. This embodiment will be explained in further detail below with reference to accompanying figures. In some embodiments, the correction is applied to the locations of the pixels in the image grid during the setup stage, before the data is collected and processed.

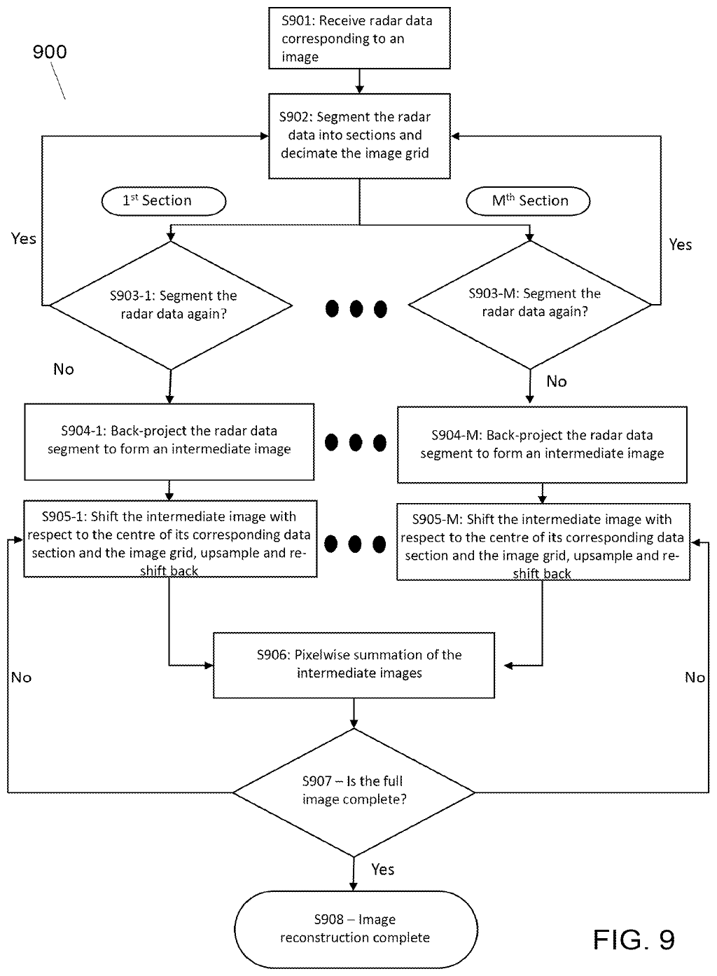

FIG. 9 shows a flowchart depicting a method 900 for performing decimation-in-image BP, according to the conventional approach. Decimation-in-image BP is another method of image reconstruction, which can again be used to reconstruct an image based on data received at a radar system.

The conventional decimation-in-image BP process 900 commences with step S901, at which radar data corresponding to an image is received from a radar system. The image may contain one or more target objects. In some embodiments, the radar data comprises signals received and demodulated at the radar system from a set of P emitted pulses. The radar data may be stored two-dimensionally, along fast and slow time axes. In some embodiments, the full image may be a two-dimensional image, of size N×N, and the data may comprise data received from P=O(N) pulses. In alternative embodiments, the full image may be a three-dimensional image, of size N×N×N, and the data may comprise data received from P=O(N²) pulses.

At step S902, instead of the image being segmented into multiple sub-images, the radar data is segmented into sections and the image grid is correspondingly decimated. The segmentation may be carried out such that the radar data is segmented into multiple sections, wherein combination of all sections would result in the complete radar data. In some embodiments, the radar data may be segmented into equally-sized sections. The segmentation of the data may be performed by dividing the data at the halfway point of the axes corresponding to each dimension. Correspondingly, the image may be decimated by a factor of 2 in each axis corresponding to each dimension.

At step S903, it may be determined for each section of the radar data whether the section is to be further segmented. In some embodiments, the radar data may be iteratively segmented. In some embodiments, the radar data may be iteratively segmented until a maximum level of decomposition is reached. In some embodiments, the maximum depth of hierarchical decomposition may be determined to have been reached when the section contains only one element of data. If the method determines that the maximum depth of hierarchical decomposition has not been reached, it may begin another iteration of hierarchical decomposition on each section of the radar data, segmenting them further.

Steps S903 to S906 may be carried out independently and in parallel for each section. In FIG. 9, S903-1 refers to step S903 as carried out on the 1^{st} section, while S903-M refers to step S903 as carried out on the M^{th} section. While not explicitly shown in FIG. 9, steps S903 to S906 may be carried out for all of the sub-images.

At step S904, each section of the radar data may be back-projected. Back-projections of each section of the radar data may form an intermediate image in the decimated image grid.

At step S905, the image may be shifted so that the centre of the relevant data segment coincides with the centre of the complete data after the shift. This operation may be carried out separately for each sub-image. Typically, to shift the intermediate image with respect to the centre of the data segment, the image pixel at (x,y) can be multiplied by

$$exp ( \frac{\text{?}}{c} ) ,$$

$$\text{?} \text{indicates text missing or illegible when filed}$$

where \hat{t}ₚ is the fast time at the centre of data segment, tₚ is the pulse time of the centre of the segment, and A(x, y, tₚ) is the difference between the range of the pixel location (x, y) and the range of the image centre with respect to the radar at tₚ. In the conventional approach to decimation-in-image BP, the range difference for far-field targets can be obtained through:

$$A ( x , y , {t}_{p} ) = x cos ( Ω {t}_{p} ) - y sin ( Ω {t}_{p} ) \qquad ( 5 )$$

where Ω is the rotational rate of the radar in SAR imaging, or the rotational rate of the target in ISAR imaging. This expression allows quick calculation of the range difference by only two multiplications and a summation per pixel and segment, as the sinusoidal components need only to be calculated once per target imaging. Equation (6) below represents an exact expression for range difference:

$$S ( x , y , {t}_{p} ) = \sqrt{{( x cos ( Ω {t}_{p} ) - y sin ( Ω {t}_{p} ) + {r}_{0} )}^{2} + {( x sin ( Ω {t}_{p} ) + y cos ( Ω {t}_{p} ) )}^{2}} - {r}_{0} \qquad ( 6 )$$

where r₀ is the distance of the full image centre to the radar. Using equation (6) to calculate the range difference would account for the curvature of the wavefront. However, one of the benefits of equation (5) is the relative computational simplicity, allowing for faster calculation. Equation (6) adds significant computational expense to the process, and thus results in a less computationally efficient method of image reconstruction.

Once shifted, the intermediate image may then be upsampled by a factor of 2 in each direction. The upsampled intermediate images may appear to be low-resolution approximations of the final image. The upsampling of the intermediate image allows it to be combined with other intermediate images in the next step and approach the full resolution complete image. Once upsampled, the image may be re-shifted back to its original location, by multiplying each image pixel by exp(−4π(f_{c}+μ\hat{t}ₚ)A(x, y, tₚ)/C). At step S906, the intermediate image may be combined with other images by a pixelwise summation to form a higher resolution intermediate image. Intermediate images may be combined in groups of four at a time. Each group of four intermediate images may be comprised of four images formed from four neighbouring sections of radar data. The higher resolution intermediate image may represent a new larger data segment comprising four neighbouring sections of radar data. At step S907, the method may determine if all of the intermediate images have been combined. If all intermediate images have been combined, then the image reconstruction is determined to be complete. If there are still multiple intermediate images, the method may repeat steps S905 and S906 until all of the intermediate images have been upsampled and combined. The shift in the repeated step S905 is with the respect to the centre of the new larger data segment and the higher resolution intermediate image grid.

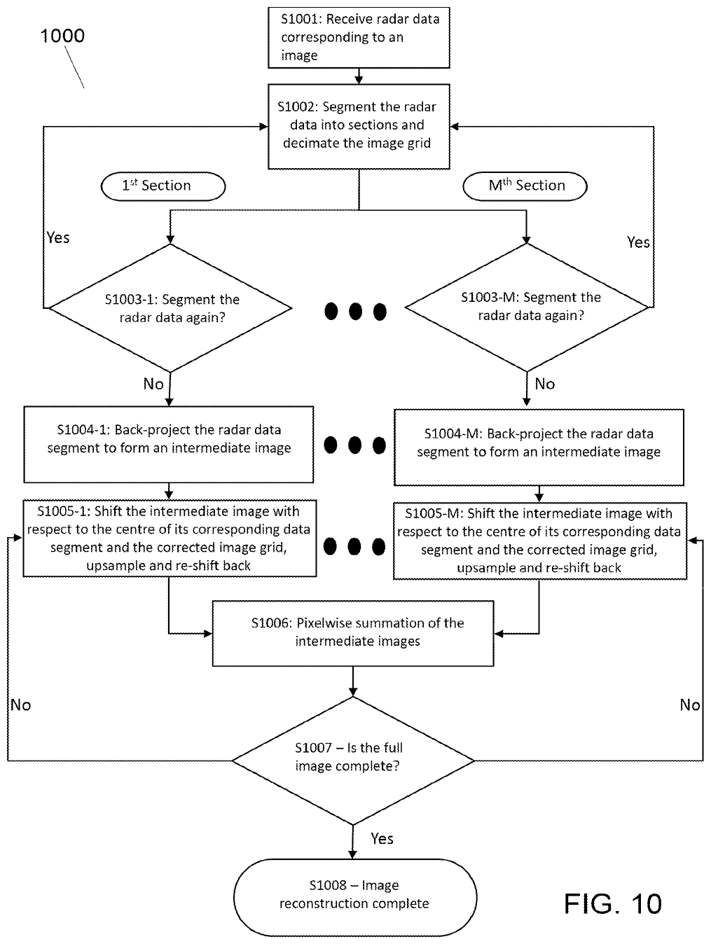

FIG. 10 shows a flowchart depicting a method 1000 for performing corrected decimation-in-image BP to account for wavefront curvature without additional computational complexity, according to embodiments.

The decimation-in-image BP process 1000 commences with step S1001, at which radar data corresponding to an image is received from a radar system. The image may contain one or more target objects. In some embodiments, the radar data comprises signals received and demodulated at the radar system from a set of P emitted pulses. In some embodiments, the full image may be a two-dimensional image, of size N×N, and the data may comprise data received from P=O(N) pulses. In alternative embodiments, the full image may be a three-dimensional image, of size N×N×N, and the data may comprise data received from P=O(N²) pulses.

At step S1002, the radar data is segmented into sections and the image grid is correspondingly decimated. The segmentation may be carried out such that the radar data is segmented into multiple sections, wherein combination of all sections would result in the complete radar data. In some embodiments, the radar data may be segmented into equally-sized sections. The segmentation of the data may be performed by dividing the data at the halfway point of the axis corresponding to each dimension. Correspondingly, the image may be decimated by a factor of 2 in each axis corresponding to each dimension.

At step S1003, it may be determined for each section of the radar data whether the section is to be further segmented. In some embodiments, the radar data may be iteratively segmented. In some embodiments, the radar data may be iteratively segmented until a maximum level of decomposition is reached. In some embodiments, the maximum depth of hierarchical decomposition may be determined to have been reached when the section contains only one element of data.

Steps S1003 to S1006 may be carried out independently and in parallel for each segment. In FIG. 10, S1003-1 refers to step S1003 as carried out on the 1^{st} section, while S1003-M refers to step S1003 as carried out on the M^{th} section. While not explicitly shown in FIG. 10, steps S1003 to S1006 may be carried out for all of the sub-images.

At step S1004, each section of the radar data may be back-projected. Back-projections of each section of the radar data may form an intermediate image in the decimated image grid.

At step S1005, each intermediate image may be shifted and upsampled by a factor of 2 in each direction. The upsampled intermediate images may appear to be low-resolution approximations of the final image. The corrected decimation-in-image BP method, according to embodiments, implements a correction to the shifting step, to account for the wave curvature when calculating the range difference. The intermediate image is shifted using the same expression as before, but to facilitate the use of equation (5) while still accounting for the wave curvature, a correction can be introduced to the pixels locations (x, y) of the image. If the ratio

$$γ = \frac{{r}_{s}}{{r}_{0}} < 0.4 ,$$

the pixels locations can be approximated with

$$\hat{y} = y + \frac{{x}^{2}}{2 {r}_{0}} - \frac{{yx}^{2}}{2 {r}_{0}^{2}} \qquad ( 7 )$$

$$\hat{x} = x - \frac{x y}{{r}_{0}} - \frac{x ( {x}^{2} - 2 {y}^{2} )}{2 {r}_{0}^{2}} \qquad ( 8 )$$

where (\hat{x},ŷ) represents the corrected pixel locations of the image. By using the corrected image grid, the image reconstruction method can take into account the curvature of the wavefront, hence reducing distortion of images of large targets at near-field while maintaining a low computational cost. This operation assumes that the integration angle is smaller than 30°. Further, the approximations in equations (7) and (8) depend only on the size and location of the full image, which means they can be pre-calculated prior to imaging. Once upsampled, the image may be re-shifted back to its original location, by multiplying each image pixel by

$$exp ( \frac{\text{?}}{c} ) .$$

$$\text{?} \text{indicates text missing or illegible when filed}$$

At step S1006, the intermediate image may be combined with other intermediate images by a pixelwise summation to form a higher resolution image. Intermediate images may be combined in groups of four at a time. Each group of four intermediate images may be comprised of four images formed from four neighbouring sections of radar data. The higher resolution intermediate image may represent a new larger data segment comprising four neighbouring sections of radar data.

At step S1007, the method may determine if all of the intermediate images have been combined. If all intermediate images have been combined, then the image reconstruction is determined to be complete. If there are still multiple intermediate images, the method may repeat steps S1005 and S1006 until all of the intermediate images have been upsampled and combined. The shift in the repeated step S1005 is with the respect to the centre of the new larger data segment and the higher resolution intermediate image grid.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

While certain embodiments have been described, these embodiments have been presented by way of example only and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. A method of near-field radar image reconstruction from radar data, the method comprising:
receiving radar data corresponding to an image;
segmenting the image into multiple sub-images, wherein each sub-image comprises a section of the image, and for each sub-image:
generating shifted data, by multiplying the radar data by a shifting term, wherein the shifting term accounts for a distance between the centre of the image and a centre of the sub-image, wherein the centre of the sub-image is corrected for a curvature of a wavefront of a radar pulse;
generating reduced data by filtering and downsampling the shifted data, such that the total amount of the shifted data is reduced; and
reconstructing the sub-image, by back-projecting the reduced data;
wherein performing the shifting by using the shifting term reduces distortion in the reconstructed sub-image.

2. The method of claim 1, further comprising shifting the reduced data, by multiplying the reduced data by an inverse shifting term before reconstructing, wherein the inverse shifting term shifts the reduced data to its original location.

3. The method of claim 2, wherein the steps consisting of segmenting the image, generating shifted data, generating reduced data and shifting the reduced data are performed iteratively, wherein at least one of the sub-images at the end of one iteration becomes the image to be segmented in the next iteration.

4. The method of claim 3, performed iteratively until a maximum level of decomposition for all sub-images is reached, and wherein the maximum level of decomposition for a sub-image is determined to have been reached when the sub-image comprises a single pixel or a single voxel of the image.

5. The method of claim 3, performed iteratively until a maximum level of decomposition for all sub-images is reached, and wherein the maximum level of decomposition for a sub-image is determined to have been reached when the sub-image contains no data representative of a target object.

6. The method of claim 3, wherein the shifting of the reduced data at the end of one iteration, and the segmentation of the image and generation of shifted data of a subsequent iteration are performed as one multiplication.

7. The method of claim 1, wherein the centre of the sub-image is corrected for the curvature of the wavefront using the following approximation:
$${\hat{y}}_{s} = {y}_{s} + \frac{{x}_{s}^{2}}{2 {r}_{0}} - \frac{{y}_{s} {x}_{s}^{2}}{2 {r}_{0}^{2}} . \qquad i$$
$${\hat{x}}_{s} = {x}_{s} - \frac{{x}_{s} {y}_{s}}{{r}_{0}} - \frac{{x}_{s} ( {x}_{s}^{2} - 2 {y}_{s}^{2} )}{2 {r}_{0}^{2}} . \qquad ii$$
wherein (\hat{x}ₛ,ŷₛ) is the corrected centre of the sub-image, (xₛ,yₛ) is the original centre of the sub-image, and r₀ is the distance of a centre of the image to the radar.

8. The method of claim 1, wherein the image is a two-dimensional image, and wherein segmenting the image into multiple sub-images consists of segmenting the image into four sub-images, wherein each sub-image is a quarter of the image.

9. The method of claim 1, wherein the image is a three-dimensional image, and wherein segmenting the image into multiple sub-images consists of segmenting the image into eight sub-images, wherein each sub-image is an eighth of the image.

10. The method of claim 1, where the data is received by a mmWave radar system.

11. The method of claim 1, wherein the target object is of a size approximately comparable with its distance from the radar system.

12. A method of near-field radar image reconstruction from radar data, the method comprising:
receiving radar data corresponding to an image;
segmenting the radar data into multiple data sections, and for each data section:
back-projecting the data section to form an intermediate image;
shifting the intermediate image by multiplying each pixel of the intermediate image by a shifting term, wherein the shifting term accounts for a distance between a centre of the data segment and a corrected image grid, wherein the corrected image grid accounts for a curvature of a wavefront of a radar pulse;
upsampling the intermediate image;
aggregating the intermediate image with intermediate images formed from other data sections of the multiple data sections.

13. The method of claim 12, further comprising shifting the intermediate image after upsampling, by multiplying each pixel of the intermediate image by an inverse shifting term before aggregating, wherein the inverse shifting term shifts the intermediate image to its original location.

14. The method of claim 12, wherein the radar data is segmented iteratively, generating progressively smaller data sections.

15. The method of claim 14, wherein the radar data segmentation iterates until a maximum level of decomposition for each data section is reached.

16. The method of claim 15, wherein the maximum level of decomposition is determined to have been reached when the data section comprises a single element of data.

17. The method of claim 14, wherein the intermediate images are aggregated iteratively until a single image is formed.

18. The method of claim 12, wherein the corrected image grid accounts for the curvature of the wavefront using the following approximation:
$$\hat{y} = y + \frac{{x}^{2}}{2 {r}_{0}} - \frac{{yx}^{2}}{2 {r}_{0}^{2}} . \qquad i$$
$$\hat{x} = x - \frac{xy}{{r}_{0}} - \frac{x ( {x}^{2} - 2 {y}^{2} )}{2 {r}_{0}^{2}} . \qquad ii$$
wherein (\hat{x},ŷ) is a corrected pixel location in the image, (x,y) is an original pixel location in the image, and r₀ is a distance between a full image centre and a radar sensor.

19. The method of claim 12, wherein the data is received by a mmWave radar system, and/or wherein the target object is of a size approximately comparable with its distance from the radar system.

20. A non-transitory computer-readable storage medium comprising computer executable instructions that when executed by a computer will cause the computer to, upon receiving radar data corresponding to an image:
segment the image into multiple sub-images, wherein each sub-image comprises a section of the image, and for each sub-image:
generate shifted data, by multiplying the radar data by a shifting term, wherein the shifting term accounts for a distance between the centre of the image and a centre of the sub-image, wherein the centre of the sub-image is corrected for a curvature of a wavefront of a radar pulse;
generate reduced data by filtering and downsampling the shifted data, such that the total amount of the shifted data is reduced; and
reconstruct the sub-image, by back-projecting the reduced data;
wherein performing the shifting by using the shifting term reduces distortion in the reconstructed sub-image.
